(19) United States
(12) Patent Application Publication
(10) Pub. No.: US 2022/0067217 A1
(43) Pub. Date: Mar. 3, 2022

(54) INFORMATION PROCESSING APPARATUS, COMPUTER-READABLE RECORDING MEDIUM STORING PROGRAM, AND INFORMATION PROCESSING METHOD

(71) Applicant: FUJITSU LIMITED, Kawasaki-shi (JP)

(72) Inventor: Toshihiko Suzuki, Kawasaki (JP)

(73) Assignee: FUJITSU LIMITED, Kawasaki-shi (JP)

(21) Appl. No.: 17/347,663

(22) Filed: Jun. 15, 2021

(30) Foreign Application Priority Data
Sep. 3, 2020 (JP) 2020-148325

(51) Int. Cl. G06F 21/79; G06F 21/57; G06F 7/58; G06F 11/10

(52) U.S. Cl. CPC G06F 21/79; G06F 11/1004; G06F 7/588; G06F 21/572

(57) ABSTRACT

An information processing apparatus includes: a memory; and a processor coupled to the memory and configured to: transmit, as a first circuit for which Route of Trust (RoT) authentication is completed, a random value for use as a generator polynomial to a second circuit for which RoT authentication is performed; receive, from the second circuit, a second cyclic redundancy check (CRC) value which is generated from read-only data held by the second circuit and the random value by the second circuit; and preform the RoT authentication for the second circuit by comparing a first CRC value generated from read-only data held for the second circuit by the first circuit with the second CRC value transferred from the second circuit.

### CROSS-REFERENCE TO RELATED APPLICATION

This application is based upon and claims the benefit of priority of the prior Japanese Patent Application No. 2020-148325, filed on Sep. 3, 2020, the entire contents of which are incorporated herein by reference.

### FIELD

The embodiment discussed herein is related to an information processing apparatus, a computer-readable recording medium storing a program, and an information processing method.

### BACKGROUND

In recent years, there are cases where a chain of trust based on a Root of Trust (RoT) is constructed in a storage device in accordance with National Institute of Standards and Technology (NIST) Special Publication (SP) 800-193 which is a standard of the NIST.

Japanese Laid-open Patent Publication No. 2014-021953 and Japanese Laid-open Patent Publication No. 2015-233315 are disclosed as related art.

### SUMMARY

According to an aspect of the embodiments, an information processing apparatus includes: a memory; and a processor coupled to the memory and configured to: transmit, as a first circuit for which Route of Trust (RoT) authentication is completed, a random value for use as a generator polynomial to a second circuit for which RoT authentication is performed; receive, from the second circuit, a second cyclic redundancy check (CRC) value which is generated from read-only data held by the second circuit and the random value by the second circuit; and preform the RoT authentication for the second circuit by comparing a first CRC value generated from read-only data held for the second circuit by the first circuit with the second CRC value transferred from the second circuit.

The object and advantages of the invention will be realized and attained by means of the elements and combinations particularly pointed out in the claims

It is to be understood that both the foregoing general description and the following detailed description are exemplary and explanatory and are not restrictive of the invention.

### BRIEF DESCRIPTION OF DRAWINGS

FIG. 1 is a diagram for describing a chain of trust based on a RoT;

FIG. 2 is a sequence diagram for describing a power-on operation in a storage device serving as a related example;

FIG. 3 is a sequence diagram for describing a failover operation in the storage device serving as the related example;

FIG. 4 is a sequence diagram for describing a normal power-on operation in a case where RoT authentication is performed in the storage device serving as the related example;

FIG. 5 is a sequence diagram for describing a power-on master switching operation in a case where RoT authentication is performed in the storage device serving as the related example;

FIG. 6 is a sequence diagram for describing a RoT authentication operation performed in a Front Enclosure (FE) serving as a related example;

FIG. 7 is a block diagram schematically illustrating a hardware configuration of a storage device serving as an example of an embodiment;

FIG. 8 is a block diagram schematically illustrating a hardware configuration of a Controller Module (CM) illustrated in FIG. 7;

FIG. 9 is a block diagram schematically illustrating a hardware configuration of a Storage area network Volume Controller (SVC) illustrated in FIG. 7;

FIG. 10 is a sequence diagram for describing a power-on operation in the storage device illustrated in FIG. 7;

FIG. 11 is a sequence diagram for describing details of a falsification check operation illustrated in FIG. 10; and

FIG. 12 is a sequence diagram for describing a maintenance operation in the storage device illustrated in FIG. 7.

### DESCRIPTION OF EMBODIMENTS

NIST SP800-193 defines that firmware code is to be protected from corruption, corruption of the firmware code is to be detected, and if the corruption of the firmware code is detected, the firmware code is to be restored to a state of integrity.

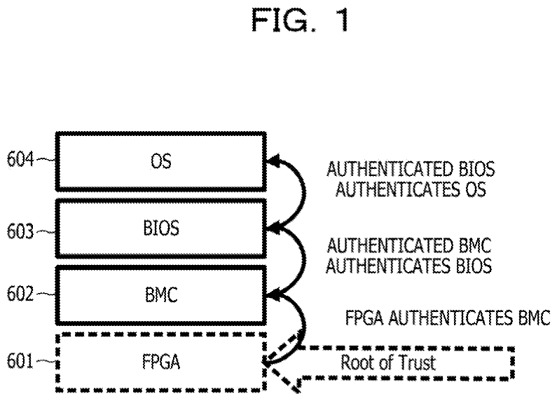

FIG. 1 is a diagram for describing a chain of trust based on a RoT.

A RoT is a part serving as a root for implementing protection, detection, and recovery of firmware code. As illustrated in FIG. 1, a field-programmable gate array (FPGA) 601 operates as a RoT. The FPGA 601 authenticates a Baseboard Management Controller (BMC) 602. The authenticated BMC 602 authenticates a Basic Input/Output System (BIOS) 603. The authenticated BIOS 603 authenticates an operating system (OS) 604.

Since the RoT itself is not authenticated, a device that operates as the RoT is to include non-rewritable code or firmware and thereby to operate normally.

However, in a case where a failure occurs in a device that operates as a RoT, a chain of trust based on the RoT may not be normally constructed.

In one aspect, it is an object to ensure construction of a chain of trust based on the RoT.

### [A] Related Example

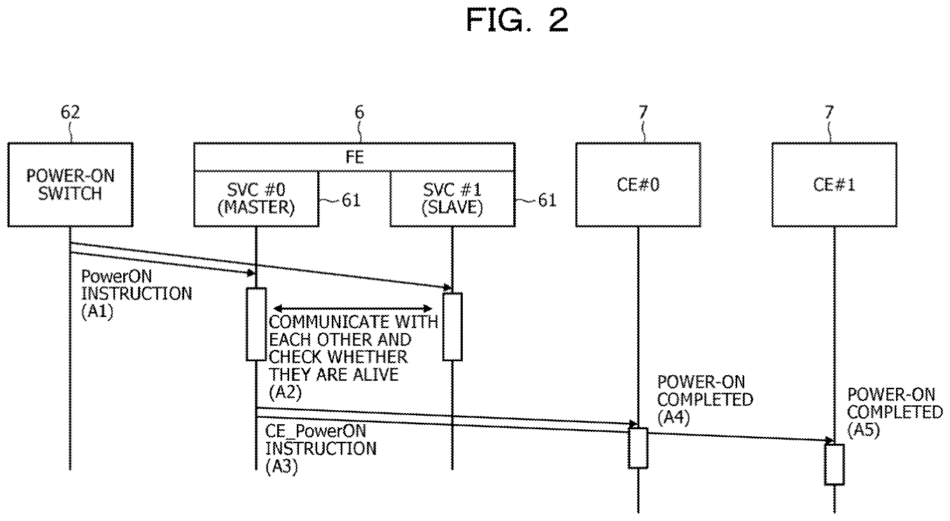

FIG. 2 is a sequence diagram for describing a power-on operation in a storage device serving as a related example.

As illustrated in FIG. 2, the storage device serving as the related example includes an FE 6 and two CEs 7 (which may also be referred to as a CE #0 or #1). The FE 6 includes two SVCs 61 (which may also be referred to as an SVC #0 or #1) and a power-on switch 62. The SVC #0 functions as a master, and the SVC #1 functions as a slave.

When the power-on switch 62 is pressed, a PowerON instruction is issued to the SVCs #0 and #1 (see a reference sign A1).

The SVCs #0 and #1 communicate with each other and check whether they are alive (see a reference sign A2).

In the example illustrated in FIG. 2, since both the SVCs #0 and #1 are alive, the SVC #0 continuously operates as the master and issues a PowerON instruction to the CEs #0 and #1 (see a reference sign A3).

Power-on is completed in the CEs #0 and #1 (see reference signs A4 and A5)

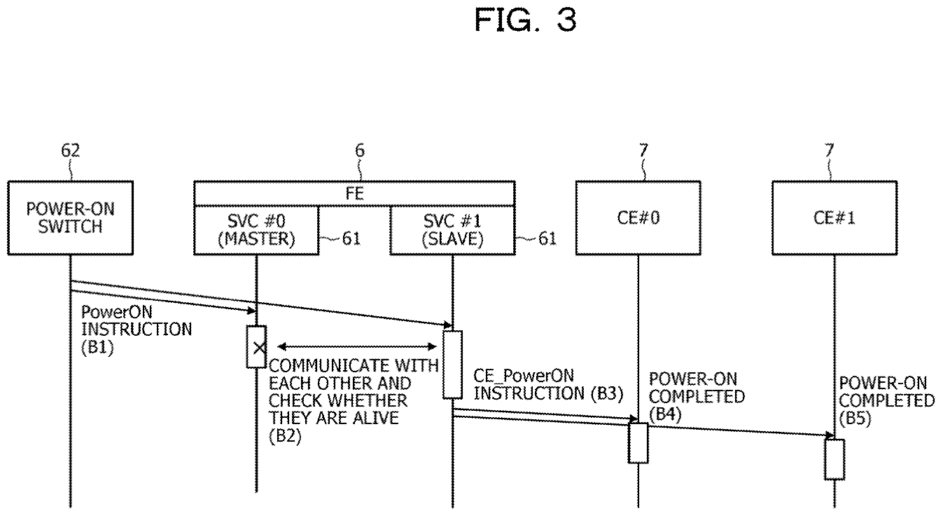

FIG. 3 is a sequence diagram for describing a faiiover operation in the storage device serving as the related example.

When the power-on switch 62 is pressed, a PowerON instruction is issued to the SVCs #0 and #1 (see a reference sign B1).

The SVCs #0 and #1 communicate with each other and check whether they are alive (see a reference sign B2).

In the example illustrated in FIG. 3, since the SVC #1 alone is alive, the SVC #1 operates as a master thereafter and issues a PowerON instruction to the CEs #0 and #1 (see a reference sign B3).

The power-on is completed in the CEs #0 and #1 (see reference. signs B4 and B5).

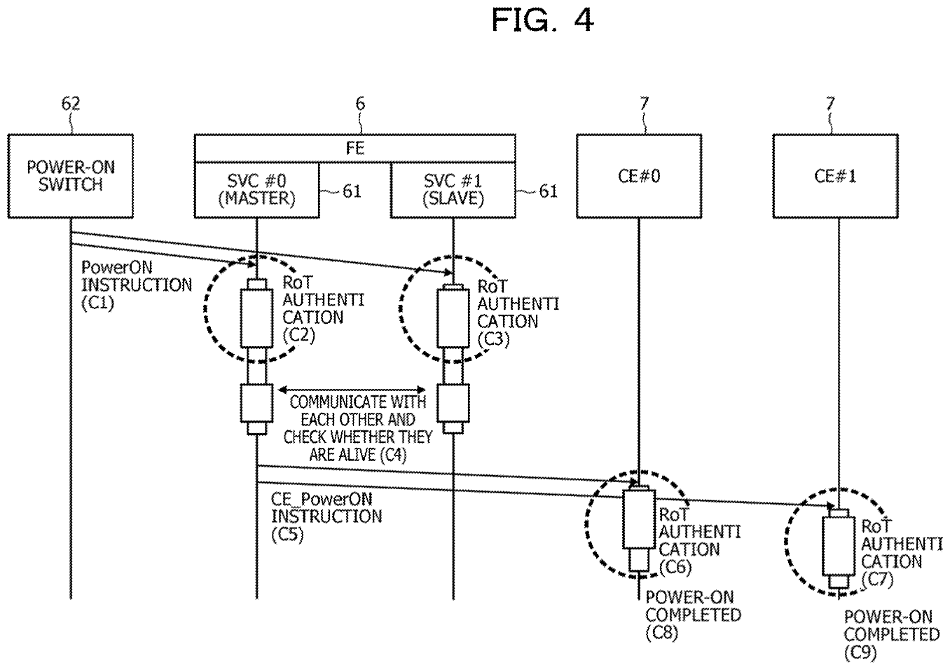

FIG. 4 is a sequence diagram for describing a normal power-on operation in a case where RoT authentication is performed in the storage device serving as the related example.

When the power-on switch 62 is pressed, a PowerON instruction is issued to the SVCs #0 and #1 (see a reference sign C1).

The SVCs #0 and #1 each perform RoT authentication (see reference signs C2 and C3).

The SVCs #0 and #1 communicate with each other and check whether they are alive (see a reference sign C4),

In the example illustrated in FIG. 4, since both the SVCs #0 and #1 are alive, the SVC #0 continuously operates as the master and issues a PowerON instruction to the CEs #0 and #1 (see a reference sign C5).

The CEs #0 and #1 each perform RoT authentication (see reference signs C6 and C7).

The power-on is completed in the CEs #0 and #1 (see reference signs C8 and C9).

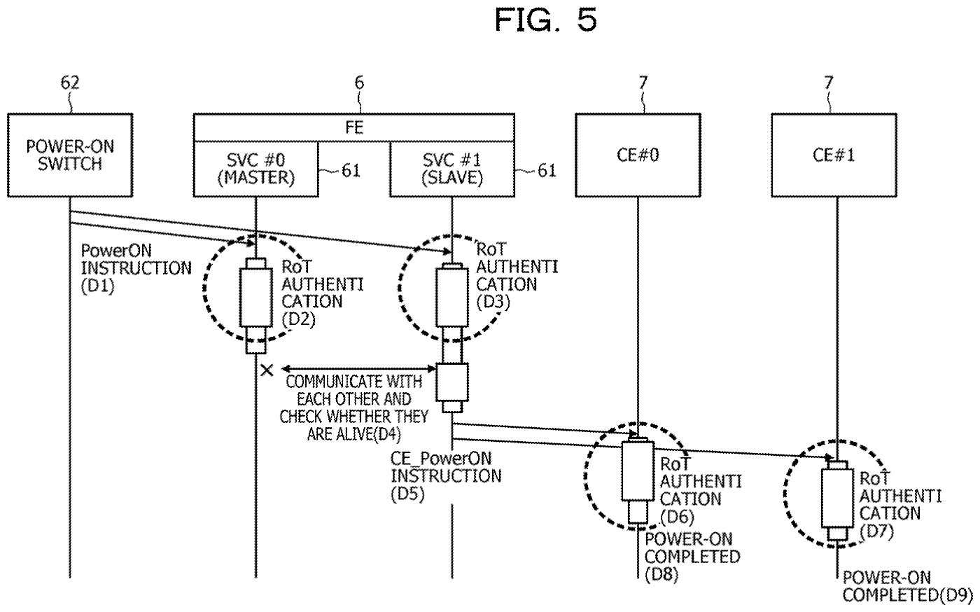

FIG. 5 is a sequence diagram for describing a power-on master switching operation in a case where RoT authentication is performed in the storage device serving as the related example.

When the power-on switch 62 is pressed, a PowerON instruction is issued to the SVCs #0 and #1 (see a reference sign D1).

The SVCs #0 and #1 each perform RoT authentication (see reference signs D2 and D3).

The SVCs #0 and #1 communicate with each other and check whether they are alive (see a reference sign D4).

In the example illustrated in FIG. 5, since the SVC #1 alone is alive, the SVC #1 operates as a master thereafter and issues a PowerON instruction to the CEs #0 and #1 (see a reference sign D5).

The CEs #0 and #1 each perform RoT authentication (see reference signs D6 and D7).

The power-on is completed in the CEs #0 and #1 (see reference signs D8 and D9).

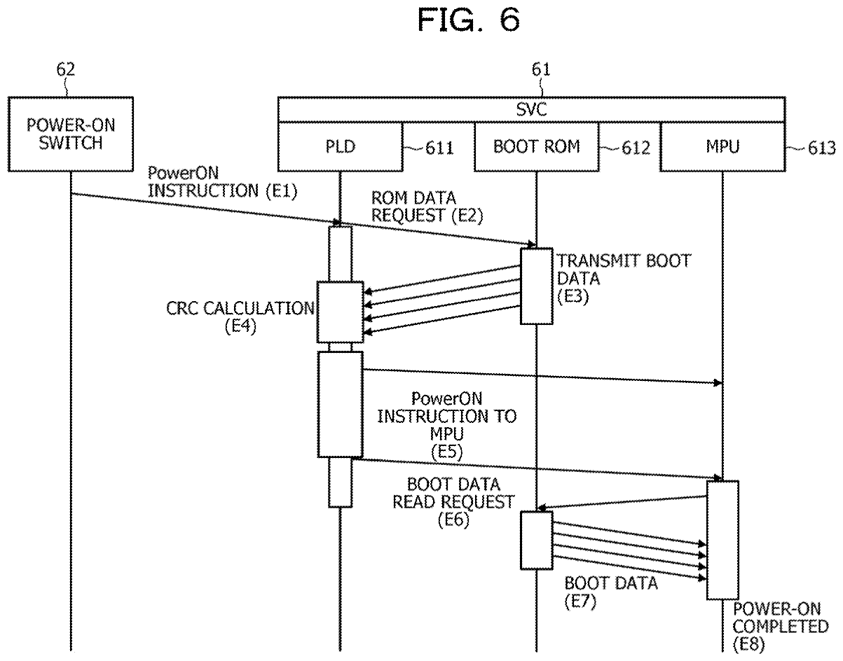

FIG. 6 is a sequence diagram for describing a RoT authentication operation performed in the FE 6 serving as a related example.

As illustrated in FIG. 6, the SVC 61 includes a programmable logic device (PLD) 611, a boot read-only memory (boot ROM) 612, and a microprocessor unit (MPU) 613.

When the power-on switch 62 is pressed, a PowerON instruction is issued to the PLD 611 (see a reference sign E1).

The PLD 611 issues a ROM data request to the boot ROM 612 (see a reference sign E2) and checks the validity of the boot ROM 612 (see a reference sign E3).

The boot ROM 612 transmits boot data to the PLD 611 (see the reference sign E3).

Based on the boot data, the PLD 611 performs a cyclic redundancy check (CRC) calculation (see a reference sign E4). The PLD 611 compares a result of the CRC calculation with an expected value of the CRC calculation stored therein. If the compared results match, it is determined that RoT authentication is successful and the power-on sequence is continued. If the compared results do not match, it is determined that RoT authentication is unsuccessful and the power-on sequence is aborted. It is assumed in the example illustrated in FIG. 6 that RoT authentication is successful.

The PLD 611 issues a PowerON instruction to the MPU 613 (see a reference sign E5).

The MPU 613 issues a boot data read request to the boot ROM 612 (see a reference sign E6), and receives the boot data (see a reference sign E7).

The power-on is completed in the MPU 613 (see a reference sign E8).

RoT authentication is to be performed in each of the FE 6 and the CE 7 that have a control function. However, when RoT authentication is performed in both the FE 6 and the CE 7, the number of parts for use in the RoT authentication increases. Consequently, the manufacturing cost of the storage device may increase. The hardware of the FE 6 and the CE 7 may have to be revised or newly designed.

### [B] Embodiment

An embodiment will described below with reference to the drawings. However, the embodiment to be described below is merely an example, and does not intend to exclude the use of various modification examples and techniques not explicitly described in the embodiment. For example, the present embodiment may be carried out in various modified forms within a scope not departing from the gist thereof. Each figure does not intend that only elements illustrated in the figure are included but other functions and the like may be included.

Since the same reference signs denote the same or similar components in the drawings, duplicate description thereof is omitted below.

### [B-1] Example of Configuration

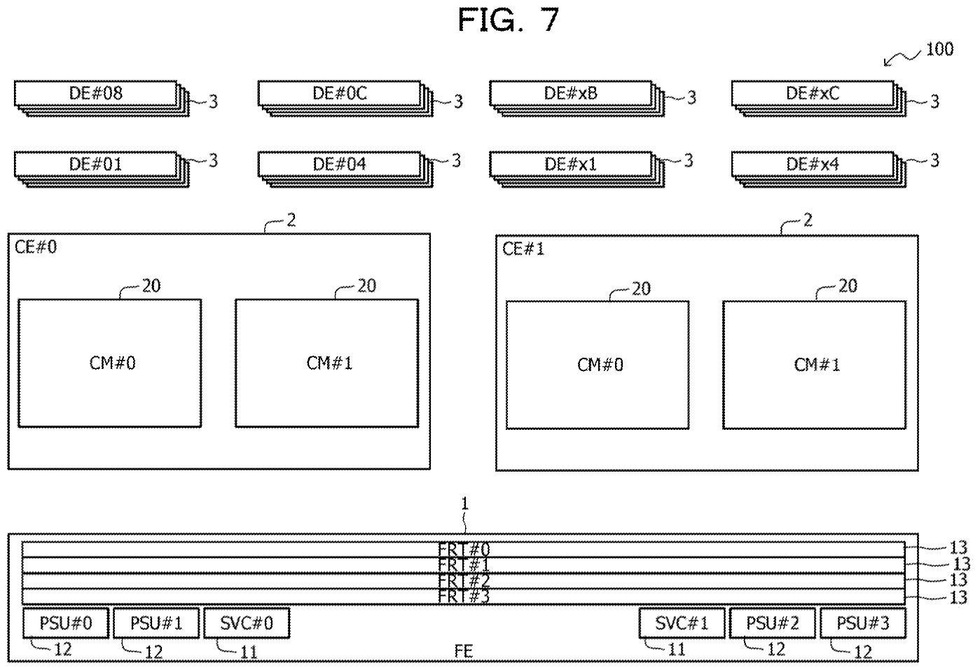

FIG. 7 is a block diagram schematically illustrating a hardware configuration of a storage device 100 serving as an example of an embodiment.

In the example of the embodiment, RoT authentication is autonomously performed limitedly in a CE 2 that controls user data, and the RoT of an FE 1 is guaranteed by the CE 2 of which the trust is guaranteed.

The storage device 100 is an example of an information processing apparatus. The storage device 100 includes the FE 1, the plurality of (two in the illustrated example) CEs 2 (which may also be referred to as a CE #0 or #1), and a plurality of Disk Enclosures (DEs) 3.

Each of the DEs 3 includes a storage device (not illustrated).

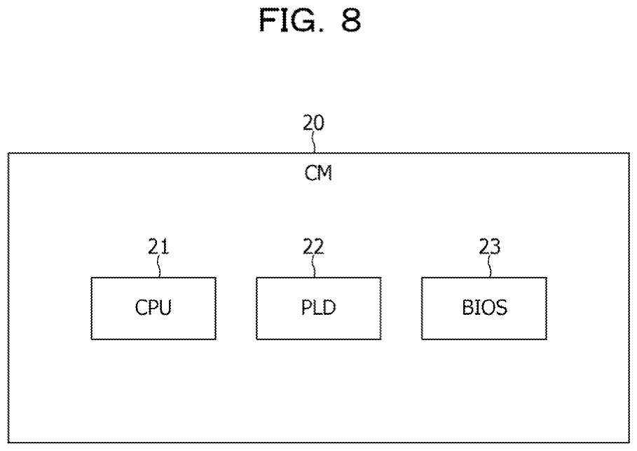

Each of the CEs 2 includes a plurality of (two in the illustrated example) CMs 20 (which may also be referred to as a CM #0 or #1). The CMs 20 each control input and output of data to and from the DEs 3. Details of the CMs 20 will be described later with reference to FIG. 8.

The FE 1 includes a plurality of (two in the illustrated example) SVCS 11 (which may also be referred to as an SVC #0 or #1), a plurality of (four in the illustrated example) power supply units (PSUs) 12 (which may also be referred to as PSUs #0 to #3), and a plurality of (four in the illustrated example) front end routers (FRTs) 13 (which may also be referred to as FRTs #0 to #3).

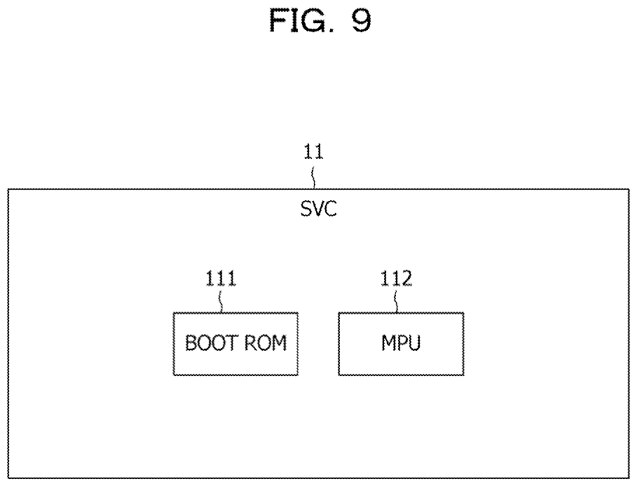

The PSUs 12 supply power to the entire FE 1. The FRTs 13 relay communication between the FE 1 and the CEs 2. The SVCs 11 perform power supply control in the entire storage device 100 and control the entire FE 1. Details of the SVCs 11 will be described later with reference to FIG. 9.

FIG. 8 is a block diagram schematically illustrating a hardware configuration of the CM 20 illustrated in FIG. 7.

The CM 20 includes a central processing unit (CPU) 21, a PLD 22, and a BIOS 23.

The CPU 21 is a processing unit that performs various kinds of control and calculations. The CPU 21 implements various functions by executing the OS and programs stored in a memory (not illustrated).

The CPU 21 performs RoT authentication for the SVC 11 by comparing a CRC value generated from read-only data held for the SVC 11 by the CM 20 with a CRC value transferred from the SVC 11.

If the CRC value generated by the CM 20 matches the CRC value transferred from the SVC 11, the CPU 21 completes the RoT authentication for the SVC 11. If the CRC value generated by the CM 20 does not match the CRC value transferred from the SVC 11, the CPU 21 causes read-only data held by the SVC 11 to be updated.

The PLD 22 is an integrated circuit to which a user is permitted to arbitrarily write a program, and performs RoT authentication for the CM 20.

The BIOS 23 is one piece of firmware, and is a program for performing the lowest-level input and output to and from hardware among programs installed in the computer.

FIG. 9 is a block diagram schematically illustrating a hardware configuration of the SVC 11 illustrated in FIG. 7.

The SVC 11 includes a boot ROM 111 and an MPU 112.

The boot ROM 111 stores a program (for example, boot data) for loading and starting the OS.

The MPU 112 is a processor that is mounted in a microchip and that performs various processes.

The MPU 112 receives a random value for use as a generator polynomial from the CM 20 for which RoT authentication is completed, generates a CRC value from read-only data held by the SVC 11 in the boot ROM 111 and from the random value, and transfers the CRC value to the CM 20.

When a power-on operation of the storage device 100 is performed, the CM 20 functions as a first unit for which RoT authentication is completed, and the SVC 11, which is a higher-level device of the CM 20, functions as a second unit subjected to a falsification check performed by the CM 20.

As illustrated in FIG. 7, there are two systems of the SVCs 11 that are the SVCs #0 and #1. Thus, the redundancy of the storage device 100 is ensured. Thus, even if one of the SVCs #0 and #1 fails, the storage device 100 is able to be continuously in operation. The failed SVC 11 is subjected to maintenance or replacement with the storage device 100 being in a power-on state.

If an SVC 11 having malicious boot ROM data stored therein is incorporated as a result of the maintenance or replacement, an operator may be warned that the maintenance part is unsuitable in addition to the boot ROM 111 being updated and restored.

When a maintenance operation is performed on the failed SVC 11, a falsification check is performed on the SVC 11 subjected to maintenance or replacement (hereinafter, referred to as the “maintenance/replacement-target SVC 11”) by the SVC 11 which is not the maintenance/replacement target and for which RoT authentication is completed.

For example, the MPU 112 of the non-maintenance/replacement-target SVC 11 performs RoT authentication for the maintenance/replacement-target SVC 11 by comparing a CRC value generated from read-only data held for the maintenance/replacement-target SVC 11 with a CRC value transferred from the maintenance/replacement-target SVC 11.

If the CRC value generated by the non-maintenance/replacement-target SVC 11 matches the CRC value transferred from the maintenance/replacement-target SVC 11, the CPU 21 of the non-maintenance/replacement-target SVC 11 completes RoT authentication for the maintenance/replacement-target SVC 11. If the CRC value generated by the non-maintenance/replacement-target SVC 11 does not match the CRC value transferred from the maintenance/replacement-target SVC 11, the CPU 21 of the non-maintenance/replacement-target SVC 11 causes the read-only data held by the maintenance/replacement-target SVC 11 to be updated.

As described above, when a maintenance operation is performed on the failed SVC 11, the two SVCs 11, which are higher-level devices of the CMs 20 and redundantly mounted in the storage device 100, function as a first unit and a second unit. The maintenance/replacement-target SVC 11 functions as the second unit.

### [B-2] Example of Operations

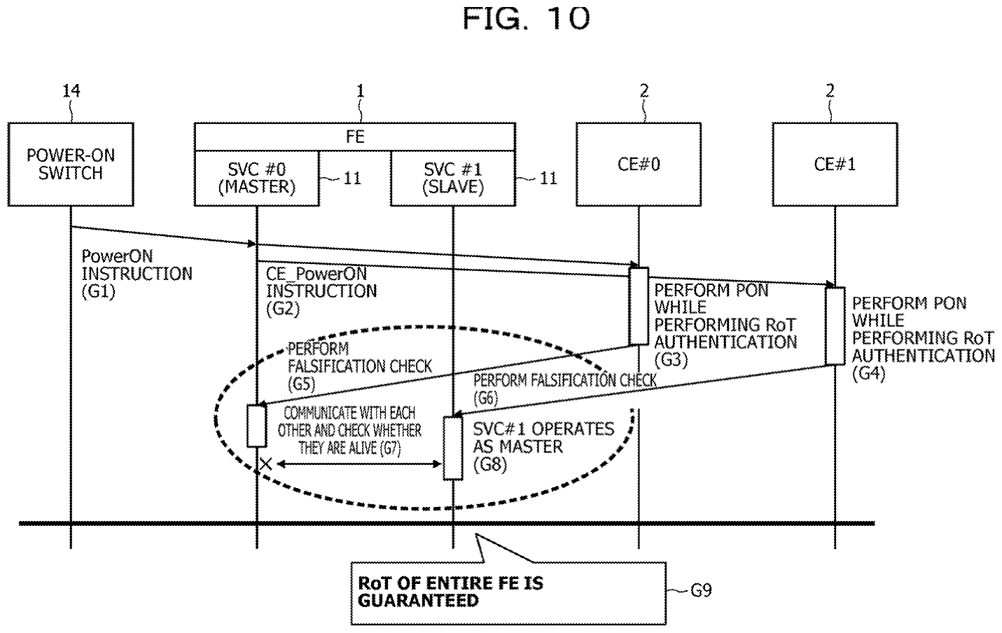

A power-on operation in the storage device 100 illustrated in FIG. 7 will be described with reference to a sequence diagram illustrated in FIG. 10.

When a power-on switch 14 included in the FE 1 is pressed, a PowerON instruction is issued to the SVC #0 serving as the master (see a reference sign G1).

The SVC #0 issues a CE_PowerCrN instruction to the CEs #0 and # 1 (see a reference sign G2).

The CEs #0 and 1 perform power-on (PON) while performing RoT authentication (see reference signs G3 and G4).

The CEs #0 and #1 perform a falsification check on the SVCs #0 and #1, respectively (see reference signs G5 and G6).

The SVCs #0 and #1 communicate with each other and check whether they are alive (see a reference sign G7).

In the example illustrated in FIG. 10, since a falsification is confirmed in the SVC #0, the normal SVC #1 operates as the master thereafter (see a reference sign G8).

Thus, the RoT of the entire FE 1 is guaranteed (see a reference sign G9),

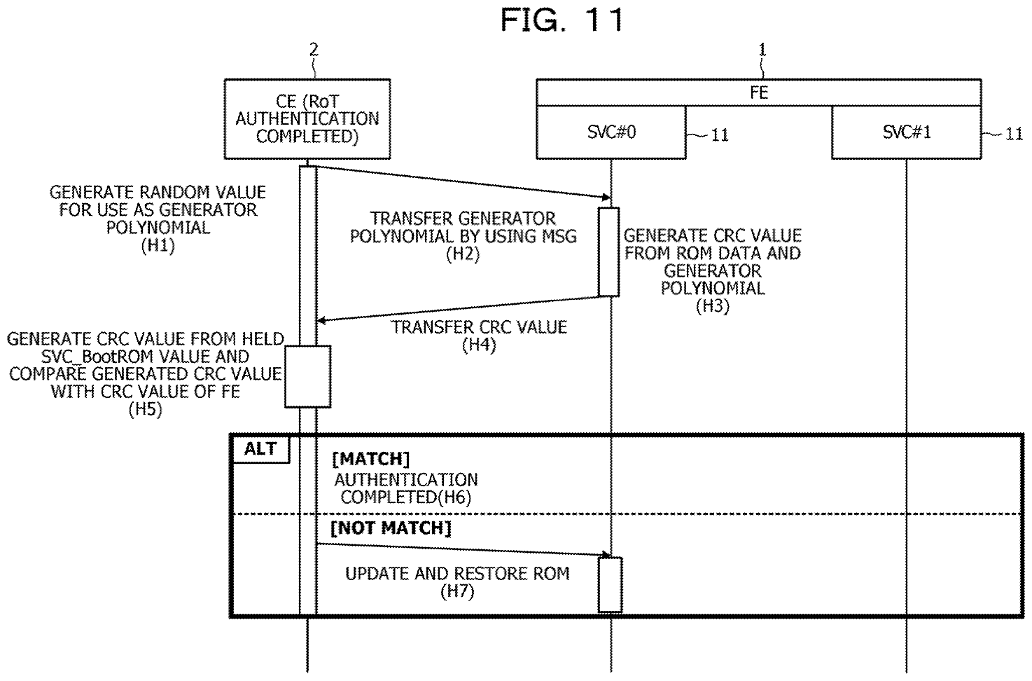

Details of the falsification check operation illustrated in FIG. 10 will be described with reference to a sequence diagram illustrated in FIG. 11.

The CPU 21 of the CE 2 for which RoT authentication is completed generates a random value for use as a generator polynomial (see a reference sign H1).

The CPU 21 of the CE 2 transfers the generator polynomial to the SVC #0 by using a message (MSG) (see a reference sign H2).

The MPU 112 of the SVC #0 generates a CRC value, based on the ROM data in the boot ROM 111 and the generator polynomial received from the CE 2 (see a reference sign H3).

The SVC #0 transfers the CRC value to the CE 2 (see a reference sign H4).

The CE 2 generates a CRC value from an SVC_BootROM value held therein, and compares the generated CRC value with the CRC value transferred from the SVC #0 (see a reference sign H5).

If the CRC values match, the CE 2 completes RoT authentication for the SVC #0 (see a reference sign H6).

If the CRC values do not match, the CE 2 updates and restores the boot ROM 111 of the SVC #0 (see a reference sign H7),

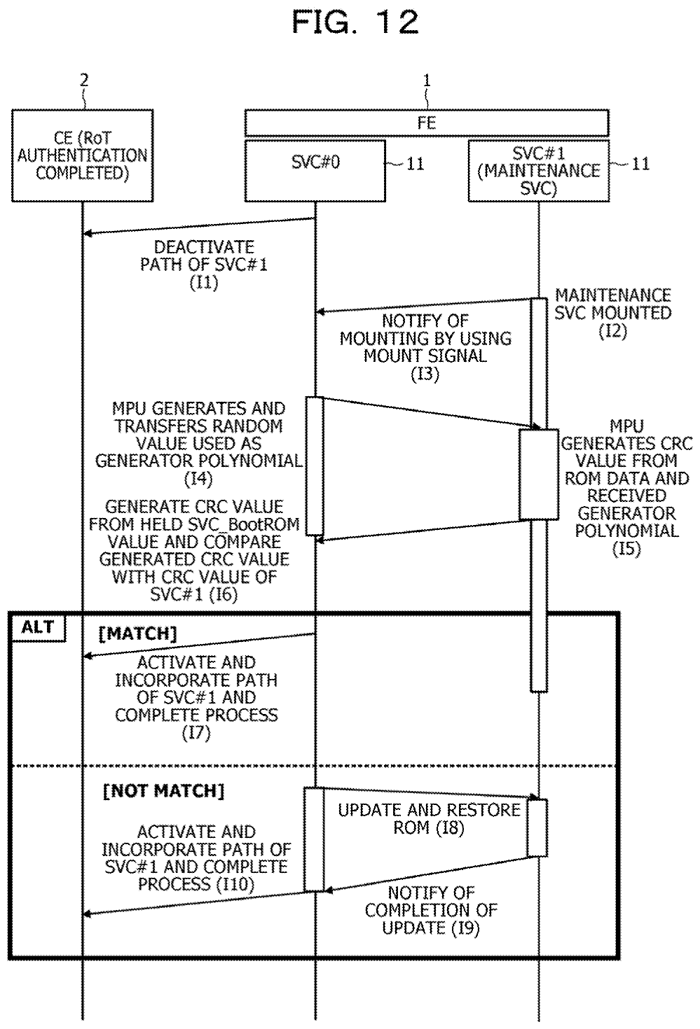

A maintenance operation in the storage device 100 illustrated in FIG. 7 will be described with reference to a sequence diagram illustrated in FIG. 12.

In a case where the SVC #1 of the FE 1 is designated as a maintenance SVC, the SVC #0 of the FE 1 notifies the CE 2 for which RoT authentication is completed, so that a path between the CE 2 and the SVC #1 is deactivated until RoT authentication of the SVC #1 is completed (see a reference sign I1).

When a maintenance SVC is mounted as the SVC #1 (see a reference sign I2), the SVC #1 notifies, by using a mount signal, the SVC #0 that the maintenance SVC is mounted (see a reference sign I3).

The MPU 112 of the SVC #0 generates a random value for use as a generator polynomial and transfers the generated random value to the SVC #1 (refer to reference sign I4).

The MPU 112 of the SVC #1 generates a CRC value, based on the ROM data of the boot ROM 111 and the generator polynomial received from the SVC #0, and transfers the CRC value to the SVC #0 (see a reference sign I5).

The SVC #0 generates a CRC value from the SVC_BootROM value held therein, and compares the generated CRC value with the CRC value transferred from the SVC #1 (see a reference sign I6).

If the CRC values match, by notifying the CE 2 of the result, the SVC #0 activates and incorporates the path between the CE 2 and the SVC #1 and completes the maintenance operation (see a reference sign I7).

If the CRC values do not match, the SVC #0 updates and restores the boot ROM 111 of the SVC #1 (see a reference sign I8).

The SVC #1 notifies the SVC #0 of the completion of updating of the boot ROM 111 (see a reference sign I9).

By notifying the CE 2, the SVC #0 activates and incorporates the path between the CE 2 and the SVC #1 and completes the maintenance operation (see a reference sign I10).

### [B-3] Effects

According to the storage device 100, a program, and an information processing method in one example of the embodiment described above, for example, the following operation effects may be obtained.

The second unit receives a random value for use as a generator polynomial from a first unit for which RoT authentication is completed, generates a CRC value from read-only data held by the second unit and from the random value, and transfers the CRC value to the first unit. The first unit performs RoT authentication for the second unit by comparing a CRC value generated from read-only data held for the second unit by the first unit with the CRC value transferred from the second unit.

Thus, construction of a chain of trust based on a RoT may be ensured. For example, a PLD mounted for performing RoT authentication in the second unit may be omitted. Thus, the number of parts for used in RoT authentication may be reduced, and consequently the manufacturing cost of the storage device 100 may be reduced. The number of man-hours for revising or newly designing the hardware of the SVC 11 may be reduced.

The first unit completes RoT authentication for the second unit in a case where the CRC value generated by the first unit matches the CRC value transferred from the second unit. Thus, RoT authentication may be normally completed.

The first unit causes the read-only data held by the second unit to be updated in a case where the CRC value generated by the first unit does not match the CRC value transferred from the second unit. Thus, RoT authentication may be normally completed after the update of the read-only data.

The first unit is the CM 20, and the second unit is the SVC 11 that is a higher-level device of the CM 20. Thus, the power-on operation of the storage device 100 involving RoT authentication may be normally completed.

The first unit and the second unit are the SVCs 11 that are redundantly mounted in the storage device 100 and that are higher-level devices of the CM 20. The second unit is the maintenance/replacement-target SVC 11. Thus, RoT authentication of the maintained or replaced SVC 11 may be performed.

### [C] Others

The disclosed technique is not limited to the embodiment described above and may be carried out in various modified manners within a range not departing from the gist of the present embodiment, Each of the configurations and each of the processes described in the present embodiment may be selectively adopted or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
transmit, as a first circuit for which Route of Trust (RoT) authentication is completed, a random value for use as a generator polynomial to a second circuit for which RoT authentication is performed;
receive, from the second circuit, a second cyclic redundancy check. (CRC) value which is generated from read-only data held by the second circuit and the random value by the second circuit; and
preform the RoT authentication for the second circuit by comparing a first CRC value generated from read-only data held for the second circuit by the first circuit with the second CRC value transferred from the second circuit.

2. The information processing apparatus according to claim 1, wherein the first circuit completes the RoT authentication for the second circuit in a case where the first CRC value generated by the first circuit matches the second CRC value transferred from the second circuit.

3. The information processing apparatus according to claim 1, wherein the first circuit causes the read-only data held by the second circuit to be updated in a case where the first CRC value generated by the first circuit does not match the second CRC value transferred from the second circuit.

4. The information processing apparatus according to claim 1, wherein the first circuit is a controller module, and the second circuit is a higher-level device of the controller module.

5. The information processing apparatus according to claim 1, wherein the first circuit and the second circuit are higher-level devices, of a controller module, redundantly mounted in the information processing apparatus, and
the second circuit is a device subjected to maintenance or replacement.

6. A non-transitory computer-readable recording medium storing a program causing a computer to execute a processing, the processing comprising:
receiving, by a second circuit for which RoT authentication is performed, a random value for use as a generator polynomial from a first circuit for which Route of Trust (RoT) authentication is completed;
generating a second cyclic redundancy check (CRC) value from read-only data held by the second circuit and the random value;
transferring the second CRC value to the first circuit; and
performing, by the first circuit, the RoT authentication for the second circuit by comparing a first CRC value generated from read-only data held for the second circuit by the first circuit with the second CRC value transferred from the second circuit.

7. The non-transitory computer-readable recording medium according to claim 6, wherein the first circuit completes the RoT authentication for the second circuit in a case where the first CRC value generated by the first circuit matches the second CRC value transferred from the second circuit.

8. The non-transitory computer-readable recording medium according to claim 6, wherein the first circuit causes the read-only data held by the second circuit to be updated in a case where the first CRC value generated by the first circuit does not match the second CRC value transferred from the second circuit.

9. The non-transitory computer-readable recording medium according to claim 6, wherein the first circuit is a controller module, and the second circuit is a higher-level device of the controller module.

10. The non-transitory computer-readable recording medium according to claim 6, wherein the first circuit and the second circuit are higher-level devices, of a controller module, redundantly mounted in the information processing apparatus, and
the second circuit is a device subjected to maintenance or replacement.

11. An information processing method comprising:
receiving, by a second circuit for which RoT authentication is performed, a random value for use as a generator polynomial from a first circuit for which Route of Trust (RoT) authentication is completed;
generating a second cyclic redundancy check (CRC) value from read-only data held by the second circuit and the random value;
transferring the second CRC value to the first circuit; and
performing, by the first circuit, the RoT authentication for the second circuit by comparing a first CRC value generated from read-only data held for the second circuit by the first circuit with the second CRC value transferred from the second circuit,

12. The information processing method according to claim 11, wherein the first circuit completes the RoT authentication for the second circuit in a case where the first CRC value generated by the first circuit matches the second CRC value transferred from the second circuit.

13. The information processing method according to claim 11, wherein the first circuit causes the read-only data held by the second circuit to be updated in a case where the first CRC value generated by the first circuit does not match the second CRC value transferred from the second circuit.

14. The information processing method according to claim 11, wherein the first circuit is a controller module, and the second circuit is a higher-level device of the controller module.

15. The information processing method according to claim 11, wherein the first circuit and the second circuit are higher-level devices, of a controller module, redundantly mounted in the information processing apparatus, and the second circuit is a device subjected to maintenance or replacement.
